(19) United States
(12) Patent Application Publication
(10) Pub. No.: US 2021/0386138 A1
(43) Pub. Date: Dec. 16, 2021

(54) PERSONAL PROTECTIVE POSITIVE PRESSURE DEVICE

(71) Applicant: Rosemount Aerospace Inc., Burnsville, MN (US)

(72) Inventor: John Carl Christenson, Prior Lake, MN (US)

(21) Appl. No.: 17/301,593

(22) Filed: Apr. 8, 2021

Related U.S. Application Data
(60) Provisional application No. 63/037,446, filed on Jun. 10, 2020.

(51) Int. Cl. A41D 13/11; A62B 9/02; A62B 9/06; A62B 9/04; A62B 7/10

(52) U.S. Cl. CPC A41D 13/1161; A62B 9/02; A62B 7/10; A62B 9/04; A62B 9/06

(57) ABSTRACT

A personal protective positive pressure device includes a mask with an inlet connector and a tube with a first connector and a second connector. The tube is connected through the first connector to the inlet connector of the mask and the tube is connected through the second connector to an air nozzle of a ventilation system onboard a transportation vehicle. The personal protective positive pressure device is configured to limit inhalation of airborne pathogens while traveling on the transportation vehicle and to inspire confidence in the safe use of public transportation.

### CROSS-REFERENCE TO RELATED APPLICATION(S)

This application claims the benefit of U.S. Provisional Application No. 63/037,446 filed Jun. 10, 2020 for “PERSONAL PROTECTIVE POSITIVE PRESSURE DEVICE” by John Carl Christenson.

### BACKGROUND

The present disclosure relates to a personal protective device, and in particular to a personal protective positive pressure device.

Airborne pathogens have been shown to be a risk to healthy passengers in crowded, closed spaces, including within airplanes, buses, trains, and taxis, to name a few. Recent government mandates and guidelines for social distancing cannot reasonably be met and allow transportation companies to make a profit. Customer confidence in staying safe and feeling protected while using transportation services is low. Some measures have been implemented in an effort to prevent the spread of disease and instill confidence in customers that the transportation services are safe. These measures include full cabin chemical sterilization, ultraviolet light sterilization, the use of hand sanitizers, and the requirement that customers wear cloth masks.

The preventative measures are inadequate to instill confidence in customers because sterilization and sanitation efforts are only effective at disinfecting surfaces and do not protect against airborne pathogens during transit of the transportation service. Further, sterilization and sanitation efforts do not instill confidence in customers because the customers cannot see or feel the sanitation efforts and may not be aware they were performed. In addition, cloth masks do not protect or prevent pathogens from entering an environment upon an overpressure event such as during a sneeze or a cough. When an overpressure event occurs, pathogens can enter the environment, enter another customer's mask through or around the edges of the mask, and then be inhaled by the customer. Transportation companies and providers have a perception problem and wish to reassure customers that they will be safe while in transit.

### SUMMARY

A personal protective positive pressure device is configured for use with an air nozzle of a ventilation system. The personal protective positive pressure device includes a mask and a tube. The mask includes a body surrounded by a seal at an edge, a strap coupled to the mask, a mask valve coupled to the body of the mask, and an inlet connector coupled to the mask. The inlet connector is configured to allow air to flow into the body of the mask. The tube includes a first end and a second end. A first connector is positioned at the first end of the tube and a second connector is positioned at the second end of the tube. The first connector is coupled to the inlet connector and the second connector is configured to couple to the air nozzle.

### BRIEF DESCRIPTION OF THE DRAWINGS

FIG. 1 is a schematic block diagram of a personal protective positive pressure device and a ventilation system.

FIG. 2A is a perspective view of the personal protective positive pressure device.

FIG. 2B is a perspective view of the personal protective positive pressure device with an attached tube.

FIG. 2C is a perspective view of the personal protective positive pressure device connected to an air nozzle of the ventilation system.

FIG. 3 is a perspective view of a second embodiment of the personal protective positive pressure device.

FIG. 4 is a perspective view of the personal protective positive pressure device including an in-line filter.

### DETAILED DESCRIPTION

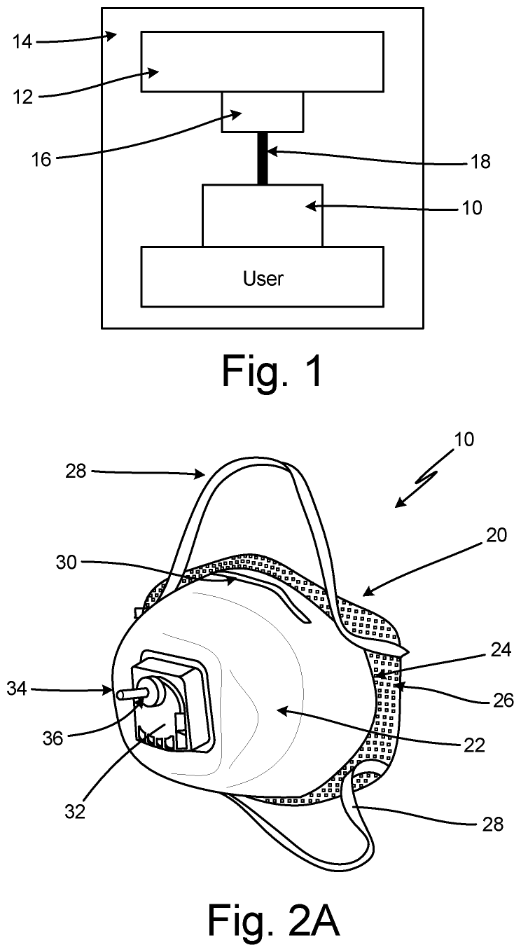

FIG. 1 is a schematic block diagram of personal protective positive pressure device 10 (hereinafter “device 10”) and ventilation system 12 onboard transportation vehicle 14. Transportation vehicle 14 includes ventilation system 12 which includes air nozzle 16. As described throughout the disclosure, transportation vehicle 14 can be an airplane, train, bus, van, taxi, AMTRAK, or other type of vehicle capable of transporting passengers from one location to another. Ventilation system 12 is a system onboard transportation vehicle 14 that is configured to filter and circulate air throughout transportation vehicle 14. Ventilation system 12 is also configured to control the temperature, velocity, and/or volume of the air circulating throughout transportation vehicle 14. In some examples, ventilation system 12 can include a high-efficiency particulate air (HEPA) qualified air filter to remove particles from the air circulating throughout transportation vehicle 14. A HEPA qualified air filter must remove 99.95% (European standard) or 99.97% (ASME, U.S. DOE standard) of particles whose diameter is equal to or greater than 0.3 μm. The HEPA filter ensures clean and safe air is being circulated throughout ventilation system 12 and into transportation vehicle 14.

For comparison, an N95 respirator mask filters out 95% of particles whose diameter is equal to or greater than 0.3 μm. HEPA filtered air, to the American standard, allows only 3 particles of every 10,000 to pass through the filter. In contrast, an N95 respirator mask, the standard for personal protection equipment of medical professionals working in infectious disease environments (including such diseases as SARS, Ebola, coronaviruses, and the like) allows 500 particles of every 10,000 to pass through the mask. The minimum standard HEPA filtered air is at least 166 times better at stopping particulates, which includes airborne pathogens. Some HEPA filters may be even more efficient at stopping particulate than the minimum standard provided by the above definition, depending on the type of filter and the specific application.

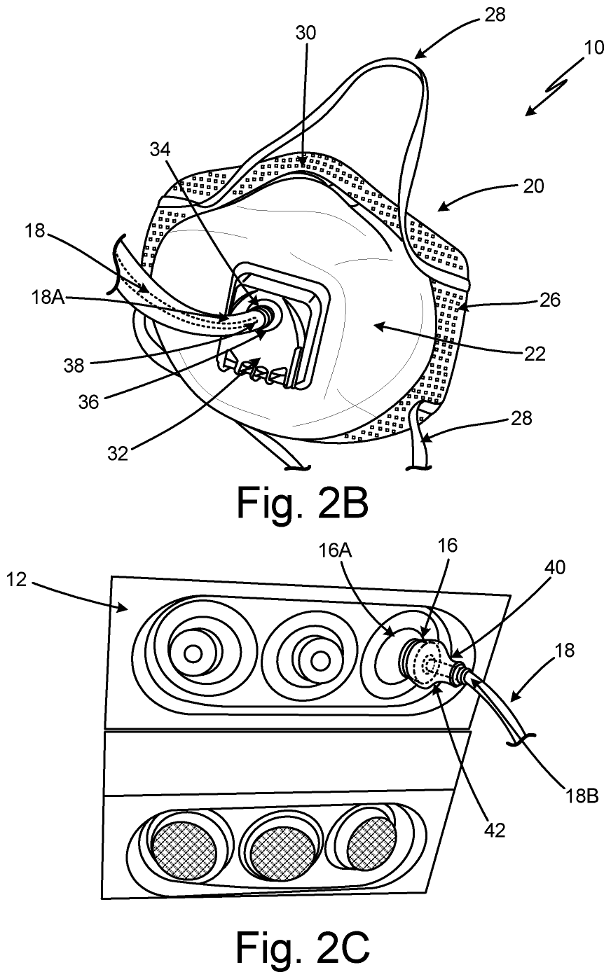

Ventilation system 12 includes air nozzle 16 configured to direct and jet clean air from ventilation system 12 to the interior of transportation vehicle 14. In some embodiments, air nozzle 16 can include ball joint 16A (shown in FIG. 2C), allowing the passenger of transportation vehicle 14 to adjust the direction of the air exiting air nozzle 16. Further, in some embodiments air nozzle 16 can include adjustment features allowing the passenger to adjust the velocity and volume of the air flowing from air nozzle 16. The adjustment features allow the passenger to alter the direction and velocity of the air exiting air nozzle 16 to satisfy a passenger's comfort level. As such, air nozzles 16 of ventilation system 12 are configured to regulate airflow volume, allowing passengers to regulate the airflow to their own personal comfort level. As shown in FIG. 1, air nozzle 16 can be coupled to tube 18 which is then coupled to device 10. Device 10 can then be coupled to or adjacent a user or passengers face to provide clean air from ventilation system 12 directly to a passenger or user, discussed further below.

FIG. 2A is a perspective view of device 10. FIG. 2B is a perspective view of device 10 with an attached tube 18. FIG. 2C is a perspective view of device 10 connected to air nozzle 16 of ventilation system 12. FIGS. 2A-2C will be discussed together. Device 10 includes tube 18 and mask 20. Mask 20 includes body 22, edge 24, seal 26, strap 28, nosepiece 30, mask valve 32, inlet connector 34, and inlet connector valve 36. Tube 18 includes first end 18A, second end 18B, first connector 38, second connector 40, and second connector valve 42.

Body 22 of mask 20 is the main portion of mask 20 in which other components of mask 20 are coupled. Body 22 is sized and configured to fit around and adjacent a user's face, specifically a user's mouth and nose. Body 22 can be constructed from materials comprising, but not limited to, a fiber material, N95-type filter material, or a clear polymer material. A clear polymer material could be used for crew/workers on transportation vehicle 14 to allow passengers to read the crew/workers lips for enhanced communication purposes. Further, body 22 is configured to filter out particles in the air as the user inhales through mask 20. Body 22 includes edge 24 positioned around one end of body 22. Seal 26 is positioned around and adjacent edge 24 of body 22. Seal 26 is configured to be adjacent and press against a user's face when a user is wearing mask 20. Seal 26 is configured to prevent air from entering body 22 of mask 20 and adjacent edge 24 of mask 20. As such, seal 26 is configured to prevent particles from entering body 22 of mask 20 through adjacent edge 24 of mask 20.

Strap 28 is coupled to mask 20 and strap 28 is configured to secure mask 20 to a user's face and head. In the embodiment shown, strap 28 is coupled to seal 26 but in another embodiment, strap 28 could be coupled to body 22 of mask 20. Further, in the embodiment shown, mask 20 includes two straps 28 but, in another embodiment, there can be more than or less than two straps 28. Likewise, in the embodiment shown, straps 28 are shown in a specific location, but in another embodiment, straps 28 can be positioned and attached to mask 20 in a plurality of different locations. Mask 20 includes nosepiece 30 coupled to a top portion of body 22 of mask 20. Nosepiece 30 is positioned adjacent a user's nose and is configured to compress around a user's nose to limit movement of mask 20 while a user is wearing mask 20. In the embodiment shown, nosepiece 30 is constructed from a pliable metal. In another embodiment, nosepiece 30 can be constructed from a material other than a pliable metal.

Mask valve 32 is coupled to body 22 of mask 20, specifically mask valve 32 is coupled to an outer surface of body 22 through a heat press operation. Mask valve 32 is a valve such as a check valve or flapper valve that is configured to allow airflow in a single direction through mask valve 32. More specifically, mask valve 32 is configured to allow air to flow outward from inside body 22 of mask 20 to outside body 22 of mask 20. In addition, mask valve 32 is configured to prevent air from flowing inward from outside body 22 of mask 20 to inside body 22 of mask 20 through mask valve 32. Mask valve 32 is configured to open when a user exhales a breath, allowing the exhaled breath to exit mask 20 easily and efficiently through mask valve 32. Mask valve 32 is also configured to close when a user inhales a breath, preventing air from outside mask 20 from flowing through mask valve 32 and forcing air to flow through and be filtered by body 22 of mask 20. Mask valve 32 is constructed from a polymer material, resulting in a cost effective and easily producible component. In the embodiment shown, mask 20 includes mask valve 32 but, in another embodiment, mask 20 may not include mask valve 32.

Inlet connector 34 is coupled to mask 20 and inlet connector 34 includes inlet connector valve 36 positioned within inlet connector 34. In the embodiment shown, inlet connector 34 is coupled to mask valve 32 which is attached to body 22 of mask 20. In another embodiment, inlet connector 34 can be coupled directly to body 22 below mask valve 32, on either side of mask valve 32, or any other location on body 22 of mask 20. Inlet connector 34 is configured to allow air to flow into body 22 of mask 20 through inlet connector valve 36. Inlet connector valve 36 is a valve such as a check valve or flapper valve that is configured to allow airflow in a single direction through inlet connector valve 36. More specifically, inlet connector valve 36 is configured to allow air to flow inward from outside body 22 of mask 20 to inside body 22 of mask 20 only when tube 18 is attached to inlet connector 34, discussed further below. In addition, inlet connector valve 36 is configured to prevent air from flowing outward from inside body 22 of mask 20 to outside body 22 of mask 20 though inlet connector valve 36. Inlet connector 34 and inlet connector valve 36 are constructed from a polymer material, resulting in a cost effective and easily producible component.

Mask 20 of device 10 is configured to be worn around the face of a user to cover the user's mouth and nose. Straps 28 secure mask 20 to a user's head and face and nosepiece 30 is secured on a user's nose to limit movement of mask 20 while attached to a user's head and face. Seal 26 is adjacent a user's face and is configured to prevent particles in the air from entering body 22 around edge 24 of mask 20. Mask valve 32 is configured to allow a user to easily exhale out through mask 20 while also preventing air from entering body 22 through mask valve 32 and being inhaled by a user when wearing mask 20. Inlet connector 34 and inlet connector valve 36 are configured to allow airflow through inlet connector 34 into body 22 only when tube 18 is attached to inlet connector 34, discussed further below. Mask 20 is a piece of personal protective equipment that is used to protect the wearer from airborne particles and from liquid contaminating the face of a user. Mask 20 is a respiratory protective device configured to achieve a very close facial fit and very efficient filtration of airborne particles.

As shown in FIGS. 2B-2C, tube 18 includes first end 18A, second end 18B, first connector 38, second connector 40, and second connector valve 42. First end 18A is positioned at one end of tube 18 and second end 18B is positioned at the opposite end of tube 18 from first end 18A. First connector 38 is positioned adjacent first end 18A of tube 18 and second connector 40 is positioned adjacent second end 18B of tube 18. First connector 38 has a first diameter and second connector 40 has a second diameter. The first diameter of first connector 38 of tube 18 is smaller or less than the second diameter of second connector 40 of tube 18. Second connector 40 includes second connector valve 42 positioned within second connector 40. Tube 18, first connector 38, second connector 40, and second connector valve 42 are constructed from a polymer material, resulting in a cost effective and easily producible component. Second connector valve 42 is configured to allow air to flow from air nozzle 16 to mask 20, and also configured to prevent air from flowing from mask 20 to air nozzle 16. In the embodiment shown, tube 18 includes second connector valve 42 but, in another embodiment, tube 18 may not include second connector valve 42.

First connector 38 is configured to be coupled to inlet connector 34 of mask 20 and second connector 40 is configured to be coupled to air nozzle 16 of ventilation system 12. First connector 38 is coupled to inlet connector 34 by surrounding a circumference of inlet connector 34 and overlapping at least of portion of inlet connector 34. In the embodiment shown, first connector 38 is coupled to inlet connector 34 through an interference fit in which friction secures the individual components to each other. In another embodiment, first connector 38 can be coupled to inlet connector 34 through any other air tight connection means. Second connector 40 is coupled to air nozzle 16 by surrounding a circumference of air nozzle 16 and overlapping at least of portion of air nozzle 16. In the embodiment shown, second connector 40 is coupled to air nozzle 16 through an interference fit in which friction secures the individual components to each other. In another embodiment, second connector 40 can be coupled to air nozzle 16 through any other air tight connection means.

In the embodiment shown, inlet connector 34 of mask 20 is a male connector, first connector 38 of tube 18 is a female connector, and second connector 40 of tube 18 is a female connector. In another embodiment, inlet connector 34 of the mask 20 could be a female connector, first connector 38 of tube 18 could be a male connector, and second connector 40 of tube 18 could be a male connector. In yet another embodiment, inlet connector 34, first connector 38, and second connector 40 could be any combination of male or female connectors provided that inlet connector 34 can be coupled to first connector 38 and second connector 40 can be coupled to air nozzle 16. Further, in the embodiment shown, second connector 40 is coupled to air nozzle 16 of ventilation system 12. In another embodiment, second connector 40 could be coupled to any source of air, such as a mobile source of air, including an oxygen tank or an oxygen/air mixture tank often used by patients who need a supplemental oxygen supply. In yet another embodiment, second connector 40 could be coupled to other clean air or oxygen delivery systems in private or public spaces such as terminals, waiting rooms, hospitals, nursing homes, and the like.

Device 10 is configured to limit inhalation of airborne pathogens while traveling and instill confidence in the safe use of public transportation. Device 10 is configured to create and define a flow path through which air flows from air nozzle 16 into second connector 40; the air flows through tube 18 from second end 18B to first end 18A; the air flows through first connector 38 into inlet connector 34; and the air flows into body 22 of mask 20 and then is inhaled by the user or passenger. The air flowing from air nozzle 16 and through device 10 is a continuous flow of air that is supplied by a clean air source, such as HEPA filtered air from ventilation system 12 or another clean air source. The continuous flow of air into body 22 of mask 20 creates a positive pressure within body 22 of mask 20, preventing air outside mask 20 from entering body 22 of mask 20. The positive pressure within body 22 assures that an exhaled breath of a nearby passenger on a transportation vehicle cannot be inhaled by the wearer of device 10 when connected to the clean air source. Excessive positive pressure airflow as well as an exhaled breath are purged from body 22 of mask 20 around edge 24 and seal 26 or through mask valve 32. Positive pressure within body 22 of mask 20 also results in less humidity in the air, which in turn makes it less likely that air exiting mask 20 will fog glasses worn by the user.

Mask valve 32, inlet connector valve 36, and second connector valve 42 are configured to prevent backpressure from an exhaled breath from entering ventilation system 12 or another clean air source. Mask valve 32 is configured to open when a user exhales a breath, allowing the exhaled breath to exit body 22 of mask 20 easily and efficiently through mask valve 32. Mask valve 32 is also configured to close when a user inhales a breath, preventing air from outside mask 20 from flowing through mask valve 32 and forcing air to flow through and be filtered by body 22 of mask 20. Inlet connector valve 36 is configured to allow air to flow from tube 18 through inlet connector valve 36 only when tube 18 is attached to inlet connector 34, providing clean air to the user or passenger. Inlet connector valve 36 is also configured to prevent an exhaled breath from flowing outward from inside body 22 of mask 20 into tube 18 through inlet connector valve 36. As such, inlet connector valve 36 is configured to allow clean air to enter body 22 and to prevent exhaled air from entering tube 18 and the clean air source, such as ventilation system 12. Second connector valve 42 is configured to allow clean air to flow from air nozzle 16 of the clean air source, such as ventilation system 12, into tube 18. Second connector valve 42 is also configured to prevent an exhaled breath of a user or passenger from flowing through tube 18 into the clean air source, such as ventilation system 12. As such, second connector valve 42 is configured to allow clean air to enter tube 18 and to prevent exhaled air from entering the clean air source, such as ventilation system 12.

Mask 20 of device 10 is configured to be worn by a user throughout all phases of a trip, including prior to entering a terminal, waiting areas, layovers, etc. Inlet connector 34 is attachable and detachable from first connector 38 of tube 18 and second connector 40 is attachable and detachable from air nozzle 16. This allows a user to wear mask 20 prior to entering or boarding transportation vehicle 14. Mask 20 will still provide a level a protection against airborne pathogens and particulates even when not attached to a clean air source, such as ventilation system 12. Upon boarding of transportation vehicle 14, the user can attach inlet connector 34 to first connector 38 and attach second connector 40 to air nozzle 16. While attached, the clean air source will provide clean air pumped directly into body 22 of mask 20 for safe inhalation by the user or passenger. A passenger can temporarily detach mask 20 and/or tube 18 from the clean air source if the passenger needs to move about the cabin of transportation vehicle 14, for example to use the bathroom, access luggage, stretch, etc. Upon arrival back at the passenger's seat, the passenger can then re-attach to the clean air source to receive clean air pumped directly into body 22 of mask 20 for safe inhalation by the user or passenger.

Device 10 can be used on many different types of transportation vehicles such as an airplane, train, bus, van, taxi, AMTRAK, or other type of vehicle capable of transporting passengers from one location to another. Many transportation vehicles include pre-existing air nozzles incorporated into the ventilation systems onboard the transportation vehicles. As such, the implementation costs of device 10 are low because device 10 is configured to fit the pre-existing nozzles of standard ventilation systems onboard many different transportation vehicles. If a transportation vehicle does not include the correct nozzles to mate with device 10, a retrofit of ventilation system 12 is easy and cost effective. The transportation vehicle service provider can simply replace ball joint 16A (shown in FIG. 2C) of air nozzle 16 with a different ball joint 16A and air nozzle 16 that is configured to mate with second connector 40 of device 10. Further, device 10 can easily be implemented in many ventilation systems 12 because air nozzles 16 of many ventilation systems 12 allow the user to regulate the airflow exiting air nozzle 16. As such, a user can adjust the airflow volume and/or velocity to control the amount of air that enters body 22 of mask 20. This allows the user to adjust the airflow to mask 20 to conform to their own comfort level. Device 10 is advantageous to transportation service providers because device 10 provides protection from airborne pathogens in crowded areas, device 10 is inexpensive per unit and inexpensive to implement in transportation vehicle 14, and device 10 instills confidence in passengers that it is safe to travel on crowded transportation vehicles 14.

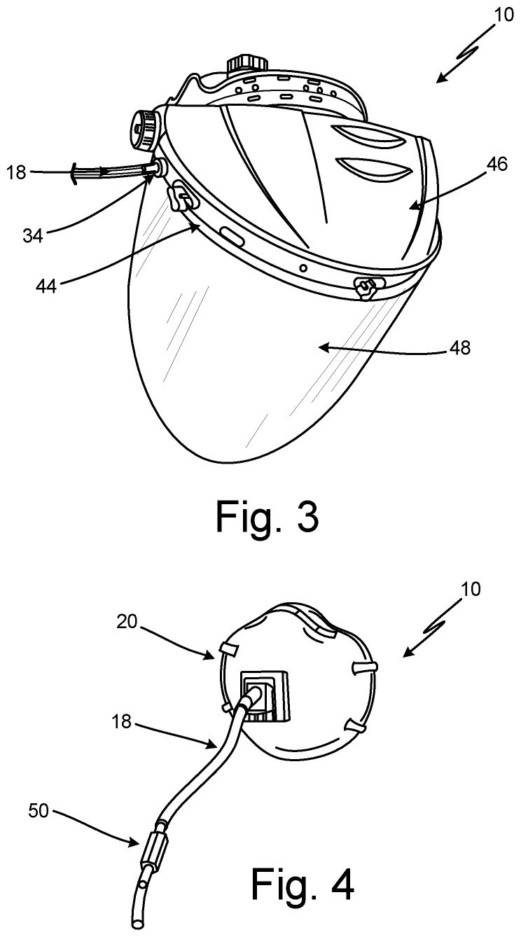

FIG. 3 is a perspective view of a second embodiment of device 10. Device 10, as shown in FIG. 3, includes tube 18, inlet connector 34, diffuser 44, head strap 46, and clear facemask 48. In this embodiment, tube 18 and inlet connector 34 operate as discussed previously with regard to the first embodiment of device 10 shown in FIGS. 2A-2C. In the second embodiment of device 10, inlet connector 34 is coupled to diffuser 44, which is coupled to head strap 46 and clear facemask 48. Head strap 46 is a component configured to be secured around a user's head while using device 10. Clear facemask 48 is positioned adjacent and coupled to head strap 46. Clear facemask 48 is attached at one end to head strap 46 and open at the other end (not attached to any other components). Clear facemask 48 is a standard facemask that protects a user's face from contact with fluids or other airborne particles while still allowing the user to see through clear facemask 48.

Diffuser 44 is coupled to head strap 46 and extends in a half-circle shape around head strap 46. In other words, head strap 46 extends approximately from one temple to another temple of a user when a user has head strap 46 secured to their head. Diffuser 44 is a hollow tube-shaped component that includes a plurality of outlet apertures spaced equally from one end of diffuser 44 to the other end of diffuser 44. Diffuser 44 is configured to receive clean air from an air source, such as ventilation system 12, through tube 18 and then through inlet connector 34. The clean air entering diffuser 44 flows through diffuser 44 from one end of diffuser 44 to the other end of diffuser 44. As the air flows through diffuser 44 the air exits each one of the plurality of outlet apertures, jetting clean air between the users face and an internal surface of clear facemask 48.

The air flowing or jetting down past the user's face creates a positive pressure within clear facemask 48. Similar to the first embodiment of device 10, the positive pressure within clear facemask 48 prevents outside air from entering clear facemask 48. As such, the second embodiment of device 10 (shown in FIG. 3) ensures passenger's wearing device 10 do not breathe other passenger or crew members' exhaled breath. Therefore, device 10 instills confidence in passengers that transportation vehicle 14 is a safe way to travel. The second embodiment of device 10 is configured to be worn by workers or crew members on board transportation vehicle 14. This embodiment allows workers or crew members to effectively communicate with the passenger's because the passenger's can read their lips and the workers or crew member's voices are not muffled by a mask covering their face. The tube connections and valves described in FIGS. 2A-2C are applicable with the second embodiment of device 10 and will not be discussed again in detail. The second embodiment of device 10 shown in FIG. 3 is an example of another device that creates a positive pressure adjacent a user's face and mouth, preventing the inhalation of airborne pathogens. Further, the second embodiment of device 10 shown in FIG. 3 can be used in conjunction with a portable clean air source to allow mobility, whilst still providing positive pressure protection to the user.

FIG. 4 is a perspective view of device 10 including in-line filter 50. As shown in FIG. 4, device 10 includes mask 20, tube 18, and in-line filter 50. Device 10 shown in FIG. 4 is essentially the same as device 10 shown in FIGS. 2A-2C with the addition of in-line filter 50. In-line filter 50 can be included in some embodiments and in-line filter 50 may not be included in other embodiments. In-line filter 50 is positioned within a portion of tube 18, anywhere along the length of tube 18. In-line filter 50 is configured to provide an additional level of protection to device 10 by filtering out even more particles within device 10. Ventilation system 12 provides clean air to tube 18, but some airborne particles may still be present in the air flowing through tube 18. In-line filter 50 is configured to further filter the air, resulting in even cleaner air than is achieved with ventilation system 12 alone. In-line filter 50 could be one of a cartridge filter, activated surface filter, activated charcoal filter, anti-viral bubbler filter, or other applicable filter. In-line filter 50 can be configured for single use or multiple use applications. Device 10 could also include a check valve (not shown) configured to accept a drinking straw, allowing a user to drink liquids through a straw without removing device 10. The check valve would open upon pressure from a drinking straw, allowing the straw to enter body 22 of mask 20. The user could drink a liquid through the straw and then the check valve would close upon removal of the straw from body 22 of device 10.

Device 10 (described in FIGS. 1-4) is configured to create a positive pressure within body 22 of mask 20, ensuring passenger's wearing device 10 do not breathe other passenger or crew members' exhaled breath. Device 10 is configured to be provided to all passengers and crew members onboard transportation vehicle 14. Device 10 is a simple design constructed from inexpensive materials, making device 10 inexpensive per person in view of increased capacity on transportation vehicle 14. Device 10 is configured to be disposable, eliminating the need to clean device 10 after each use. Device 10 is configured to be convenient and comfortable, allowing device 10 to be worn from start to completion of a travel itinerary: upon entering the terminal, in waiting areas, on the jet way, during loading, in the vehicle, during a layover, at luggage retrieval, to the terminal exit, and beyond. Device 10 instills confidence in passengers that transportation vehicle 14 is a safe way to travel.

Passengers or users can physically see and feel the protection because they can see other passenger's wearing device 10 and can feel clean air entering their individual device 10. Device 10 creates a heightened perception of safety for the passengers of transportation vehicle 14. The positive pressure within device 10 ensures that the clean air is always directing all other air, including any contaminated air outside the mask, away from the user. Device 10 allows airlines, buses, trains, motor coaches, and other transportation services to return to full capacity and full density seating due to the enhanced safety measures preventing the spread of airborne particulates. In turn, this allows the transportation service providers to increase revenue due to increased use of the transportation services. Device 10 eliminates transportation service providers perception problem and reassures passengers that they will be safe while in transit.

### Discussion of Possible Embodiments

The following are non-exclusive descriptions of possible embodiments of the present invention.

A personal protective positive pressure device is configured for use with an air nozzle of a ventilation system. The personal protective positive pressure device includes a mask and a tube. The mask includes a body surrounded by a seal at an edge, a strap coupled to the mask, a mask valve coupled to the body of the mask, and an inlet connector coupled to the mask. The inlet connector is configured to allow air to flow into the body of the mask. The tube includes a first end and a second end. A first connector is positioned at the first end of the tube and a second connector is positioned at the second end of the tube. The first connector is coupled to the inlet connector and the second connector is configured to couple to the air nozzle.

The personal protective positive pressure device of the preceding paragraph can optionally include, additionally and/or alternatively, any one or more of the following features, configurations and/or additional components:

The seal is configured to prevent air from entering the body of the mask adjacent the edge of the mask; the strap is configured to secure the mask to a user; and a nosepiece is coupled to the body of the mask and the nosepiece is configured to compress around the user's nose to limit movement of the mask.

The mask valve is configured to allow air to flow outward from inside the body of the mask to outside the body of the mask; and the mask valve is configured to prevent air from flowing inward from outside the body of the mask to inside the body of the mask through the mask valve.

The inlet connector includes an inlet connector valve positioned within the inlet connector.

The inlet connector valve is configured to allow air to flow inward from outside the body of the mask to inside the body of the mask; and the inlet connector valve is configured to prevent air from flowing outward from inside the body of the mask to outside the body of the mask though the inlet connector valve.

The inlet connector is coupled to the mask valve.

The inlet connector is positioned below or on either side of the mask valve.

The second connector of the tube includes a second connector valve.

The second connector valve is configured to allow air to flow from the air nozzle to the mask, and wherein the second connector valve is configured to prevent air from flowing from the mask to the air nozzle.

The body of the mask is constructed from materials comprising at least one of a fiber material, N95-type filter material, or a clear polymer material.

The mask valve, the inlet connector, the tube, the first connector, and the second connector are constructed from a polymer material.

The first connector surrounds a circumference of the inlet connector, and wherein the first connector is coupled to the inlet connector through an interference fit.

The second connector surrounds a circumference of the air nozzle, and wherein the second connector is coupled to the air nozzle through an interference fit.

The inlet connector of the mask is a male connector, the first connector of the tube is a female connector, and the second connector of the tube is a female connector.

A diameter of the first connector of the tube is smaller than a diameter of the second connector of the tube.

An in-line filter is positioned within a portion of the tube, and wherein the in-line filter comprises a cartridge filter or an activated charcoal filter.

The second connector, the tube, the first connector, and the inlet connector define a flow path through which air flows from the air nozzle into the second connector, the air flows through the tube from the second end to the first end, the air flows through the first connector into the inlet connector, and the air flows into the body of the mask.

The air flowing into the body of the mask is a continuous flow of air.

The continuous flow of air into the body of the mask creates a positive pressure within the body of the mask, preventing air outside the mask from entering the body of the mask.

The inlet connector is attachable and detachable from the first connector of the tube, and wherein the second connector is attachable and detachable from the air nozzle.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A personal protective positive pressure device for use with an air nozzle of a ventilation system, the personal protective positive pressure device comprising:
a mask comprising:
a body surrounded by a seal at an edge;
a strap coupled to the mask;
a mask valve coupled to the body of the mask; and
an inlet connector coupled to the mask, wherein the inlet connector is configured to allow air to flow into the body of the mask; and
a tube comprising a first end and a second end, wherein a first connector is positioned at the first end of the tube and a second connector is positioned at the second end of the tube, and wherein the first connector is coupled to the inlet connector and the second connector is configured to couple to the air nozzle.

2. The personal protective positive pressure device of claim 1, wherein:
the seal is configured to prevent air from entering the body of the mask adjacent the edge of the mask;
the strap is configured to secure the mask to a user; and
a nosepiece is coupled to the body of the mask and the nosepiece is configured to compress around the user's nose to limit movement of the mask.

3. The personal protective positive pressure device of claim 1, wherein:
the mask valve is configured to allow air to flow outward from inside the body of the mask to outside the body of the mask; and
the mask valve is configured to prevent air from flowing inward from outside the body of the mask to inside the body of the mask through the mask valve.

4. The personal protective positive pressure device of claim 1, wherein the inlet connector includes an inlet connector valve positioned within the inlet connector.

5. The personal protective positive pressure device of claim 4, wherein:
the inlet connector valve is configured to allow air to flow inward from outside the body of the mask to inside the body of the mask; and
the inlet connector valve is configured to prevent air from flowing outward from inside the body of the mask to outside the body of the mask though the inlet connector valve.

6. The personal protective positive pressure device of claim 1, wherein the second connector of the tube includes a second connector valve configured to allow air to flow from the air nozzle to the mask and prevent air from flowing from the mask to the air nozzle.

7. The personal protective positive pressure device of claim 1, and further comprising an in-line filter positioned within a portion of the tube, and wherein the in-line filter comprises a cartridge filter or an activated charcoal filter.

8. The personal protective positive pressure device of claim 1, wherein the second connector, the tube, the first connector, and the inlet connector define a flow path through which air flows from the air nozzle into the second connector, the air flows through the tube from the second end to the first end, the air flows through the first connector into the inlet connector, and the air flows into the body of the mask.

9. The personal protective positive pressure device of claim 8, wherein the air flowing into the body of the mask is a continuous flow of air, and wherein the continuous flow of air into the body of the mask creates a positive pressure within the body of the mask, preventing air outside the mask from entering the body of the mask.

10. The personal protective positive pressure device of claim 1, and further comprising a check valve configured to accept a liquid drinking straw, wherein the check valve allows a user to drink liquids through the liquid drinking straw without removing the personal protective positive pressure device.

11. A personal protective positive pressure device for use with an air nozzle of a ventilation system, the personal protective positive pressure device comprising:
a head strap coupled to a clear facemask, wherein the clear facemask is coupled to the head strap at one end and open at the other end of the clear facemask;
an inlet connector coupled to a diffuser, wherein the inlet connector is configured to allow air to flow into the diffuser; and
a tube comprising a first end and a second end, wherein a first connector is positioned at the first end of the tube and a second connector is positioned at the second end of the tube, and wherein the first connector is coupled to the inlet connector and the second connector is configured to couple to the air nozzle.

12. The personal protective positive pressure device of claim 11, wherein:
the diffuser is coupled to the head strap and extends in a half-circle shape around the head strap; and
the diffuser is a hollow tube including a plurality of outlet apertures spaced equally from one end of the diffuser to the other end of the diffuser.

13. The personal protective positive pressure device of claim 12, wherein air exits each one of the plurality of outlet apertures, flowing or jetting clean air between a user's face and an internal surface of the clear facemask, creating a positive pressure within the clear facemask and preventing outside air from entering the clear facemask.

14. The personal protective positive pressure device of claim 11, wherein the head strap is configured to be secured around a user's head while using the personal protective positive pressure device, securing the personal protective positive pressure device to the user.

15. The personal protective positive pressure device of claim 11, wherein the inlet connector includes an inlet connector valve positioned within the inlet connector.

16. The personal protective positive pressure device of claim 15, wherein:
the inlet connector valve is configured to allow air to flow inward from outside the clear facemask to inside the clear facemask; and
the inlet connector valve is configured to prevent air from flowing outward from inside the clear facemask to outside the clear facemask though the inlet connector valve.

17. The personal protective positive pressure device of claim 11, wherein the second connector of the tube includes a second connector valve, and wherein the second connector valve is configured to allow air to flow from the air nozzle to the diffuser.

18. The personal protective positive pressure device of claim 11, and further comprising an in-line filter positioned within a portion of the tube, and wherein the in-line filter comprises a cartridge filter or an activated charcoal filter.

19. The personal protective positive pressure device of claim 11, wherein the second connector, the tube, the first connector, the inlet connector, and the diffuser define a flow path through which air flows from the air nozzle into the second connector, the air flows through the tube from the second end to the first end, the air flows through the first connector into the inlet connector, and the air flows from the inlet connector into the diffuser.

20. The personal protective positive pressure device of claim 19, wherein the air flowing into the diffuser is a continuous flow of air, and wherein the continuous flow of air into the diffuser creates a positive pressure within the clear facemask, preventing air outside the clear facemask from entering an interior of the clear facemask.
